(19) United States
(12) Patent Application Publication
(10) Pub. No.: US 2012/0091833 A1
(43) Pub. Date: Apr. 19, 2012

(54) DRIVE UNIT

(75) Inventors: Douglas-Brent Hackett, Abstatt (DE); Thorsten Rohwer, Tamm (DE); Denis Kern, Stuttgart-Ost (DE); Paul Esse, Leutenbach (DE); Christian Buehnert, Leutenbach (DE); Andreas Herzberger, Remseck-Aldingen (DE); Jens Koerkemeyer, Remseck (DE)

(73) Assignee: ROBERT BOSCH GMBH, Stuttgart (DE)

(21) Appl. No.: 13/260,412

(22) PCT Filed: Feb. 19, 2010
(86) PCT No.: PCT/EP2010/052144

§ 371 Date: Jan. 3, 2012

(30) Foreign Application Priority Data
Mar. 25, 2009 (DE) 10 2009 001 838.7

(51) Int. Cl. H02K 9/19; B60K 6/22

(52) U.S. Cl. 310/53; 60/698; 180/65.21; 903/902

(57) ABSTRACT

The invention relates to an electric machine (5), in particular for a motor vehicle, comprising a housing (9), at least one shaft (8), a stator (6), a rotor (7), a cooling circuit for cooling the electric machine (5) using a liquid, in particular oil, wherein the liquid can be conveyed from at least one at least partially radially aligned channel (11) into at least one rotating part (12) of the electric machine (5) due to a rotational movement of the at least one channel (11), at least one outlet opening (13) for draining the liquid from the at least one channel (11), wherein the electric machine (5) is provided with at least one agent (14) for reducing the conveyed amount per unit time of liquid that can be conveyed from the at least one channel (11) due to the rotational movement of the at least one channel (11).

### BACKGROUND OF THE INVENTION

The present invention relates to an electric machine and a drive unit.

Drive units, preferentially hybrid drive units, in particular with a combustion engine and an electric machine are employed for example for driving motor vehicles. The electric machine acting as motor and generator in the motor vehicle comprises an axle or shaft with a stator or rotor arranged thereon.

The stator and the rotor of the electric machine are cooled by a cooling circuit by means of oil for example. The shaft is generally in two parts and consists of a rotor shaft with an axial bore and an inner shaft. In the axial bore of the rotor shaft, the inner shaft is arranged, wherein between the inner shaft and the rotor shaft a gap that is circular in cross section forms. The oil for cooling is conducted through this gap. On the rotor shaft, a balancing disk is arranged. The rotor shaft and the balancing disk are provided with radial channels through which the oil for cooling is conducted outwardly from the gap in radial direction. Because of the rotational movement of the rotor shaft and the balancing disk the channel acts as a pump. The oil exits at the end of the channels from outlet openings and because of this cools the stator and the rotor of the electric machine. Furthermore, the oil is conducted from an oil sump as coolant circuit into the gap by an additional pump. This pump, which conveys the oil from the pump sump, additionally pumps the oil to other components of the drive unit, which have to be cooled and/or lubricated, for example a differential gear, a transmission and/or the combustion engine.

Because of the rotary movement of the channels these have a pumping effect and consequently also deliver the oil. At relatively high rotational speeds of the rotor shaft and the balancing disk a great pumping action of the channels occurs. Because of this, there is the risk that for cooling and/or for lubricating the other components of the drive unit insufficient oil is available, because this is sucked in by the channels to an increased extent. Because of this, under certain conditions, these other components of the drive unit cannot be adequately cooled and/or lubricated.

DE 10 2006 008 049 A1 shows a drive unit, having the following: an engine compartment in which a stator and a rotor are accommodated; a transmission compartment, which is provided adjoining the engine compartment in the direction of the rotary axis of the rotor and in which a transmission is accommodated, wherein the rotation of the rotor is transmitted to the transmission; a bearing for supporting the rotation, both of the rotor and of the transmission; and a wall, which is arranged between the engine compartment and the transmission compartment in order to support the bearing, wherein the wall is provided with an opening so that lubricating oil sprayed by the transmission can be sprayed onto an upper section of the stator.

DE 102 38 023 B4 shows a combustion engine containing a generator or motor, whose stator comprises a core and coils attached to the core and this stator is located opposite permanent magnets, which are attached to a crankshaft of the combustion engine, wherein the combustion engine furthermore comprises a stator cooling means for cooling the stator with oil, wherein the permanent magnets are attached to the outer circumference of a crank web of the crankshaft and that the stator surrounds the crank web supporting the permanent magnets in the shape of an arc on the side facing away from the cylinder block.

DE 199 28 247 B4 shows a motor, comprising a motor housing, a stator of cylindrical shape, which is fastened to the engine housing, an inner rotor, which is rotatably arranged within the stator, an outer rotor being rotatably arranged about the stator, wherein the inner rotor, the stator and the outer rotor are arranged concentrically and comprises a plurality of bolts for fastening the stator to the motor housing, wherein a cooling system is provided, a plurality of pairs of cooling channels, which are formed in the stator, a coolant inlet opening for introducing coolant into the cooling channels, a coolant outlet opening for draining coolant from the cooling channels, wherein the coolant inlet opening and the coolant outlet opening are provided at an axial end of the inner rotor and are connected to the cooling channels, a coolant return flow section for connecting each cooling channel pair, wherein the coolant return flow section is provided in another axial end of the inner rotor, and wherein the cooling channels are formed from the stator and the plurality of the bolts.

### SUMMARY OF THE INVENTION

Electric machines according to the invention, particularly for a motor vehicle, comprising a housing, at least one shaft, a stator and a rotor, a cooling circuit for cooling the electric machine with a liquid, particularly oil, wherein the liquid can be conveyed from at least one channel aligned radially at least partially in at least one rotating part of the electric machine because of a rotational movement of the at least one channel, at least one outlet opening for draining the liquid from the at least one channel, wherein the electric machine is provided with at least one means for reducing the rate of delivery per unit time of liquid which can be conveyed by the at least one channel because of the rotational movement of the at least one channel.

The at least one means reduces the rate of delivery per unit time of liquid, which is conveyed by the at least one channel. Because of this, an even cooling independently of the rotational speed of the rotating part is advantageously possible and furthermore can also be utilized upon an integration of the electric machine in a drive unit of the cooling circuit in order to evenly cool and/or lubricate other components of the drive unit. A high rotational speed of the rotating part thus does not result in relatively large quantities of oil being sucked in by the cooling circuit so that for cooling and/or for lubricating other components of the drive unit insufficient oil is available.

Particularly, the at least one rotating part is the at least one shaft and/or a balancing disk.

In a further configuration, the at least one shaft comprises a rotor shaft with an axial bore and an inner shaft, wherein the inner shaft is arranged in the axial bore of the rotor shaft. Preferentially, the rotor shafts and the inner shaft are positively interconnected, for example by means of a toothing, so that the rotor shafts and the inner shaft have the same rotational speed and torques can be transmitted between the rotor shaft and the inner shaft.

In a complementary embodiment, between the inner shaft and the rotor shaft a gap that is circular in cross section is present for conducting the liquid.

Preferentially, the cooling circuit is provided with a pump for the additional delivery of the liquid, preferentially from a pump sump. The pump, which does not constitute the at least one radially aligned channel, conveys the oil to the at least one channel and preferentially to other components to be cooled and/or to be lubricated, for example a differential gear and/or a transmission and/or the combustion engine.

In a version, the at least one means comprises at least one air intake opening, wherein the at least one air intake opening is connected in a fluidically conductive manner to the at least one channel for reducing the rate of delivery per unit time of liquid.

Practically, the at least one air intake opening is designed radially within the at least one outlet opening and/or the at least one air intake opening is designed in the rotating part. The at least one air intake opening thus has a smaller spacing from an axis of the shaft than the at least one outlet opening. Through the at least one air intake opening, which can be connected to the atmospheric pressure of the surroundings, air can be introduced into the at least one channel so that, because of this, the vacuum that can be made available by the at least one channel is reduced at an inlet opening of the at least one channel and the rate of delivery per unit time of liquid, that can be conveyed by the at least one channel because of the rotational movement of the at least one channel, is thus reduced.

In a further embodiment, the at least one means is designed such that the reduction of the rate of delivery per unit time of liquid takes place because of the rotational movement of the at least one channel as a function of the rotational speed of the rotating part, particularly of the at least one shaft, particularly in that a flow cross-sectional area of the at least one channel is variable. Particularly, the reduction of the rate of delivery per unit time of liquid is indirectly proportional to the rotational speed of the rotating part, i.e. the higher the rotational speed of the rotating part, the greater the reduction of the rate of delivery per unit time of liquid because of the rotational movement of the at least one channel. The reduction is caused by the at least one means. The reduction is the differential from the rate of delivery per unit time of liquid in the electric machine with and without the at least one means.

In particular, the at least one means comprises at least one radial throttling element that can be at least partially moved in radial direction, wherein the at least one radial throttling element can be moved into the at least one channel by means of a centrifugal force, so that the greater the centrifugal force, the smaller the flow cross-sectional area of the at least one channel becomes.

In a further configuration, the at least one means comprises at least one elastic element, e.g. a spring, in order to move the at least one radial throttling element in the event of a diminishing centrifugal force so that in the event of a diminishing centrifugal force the flow cross-sectional area of the at least one channel is enlarged.

In a complementary version, the at least one radial throttling element and/or the at least one elastic element are arranged in the rotating part, e.g. the balancing disk.

In a further version, the at least one means comprises at least one tangential throttling element at least partially moveable in tangential direction, wherein the tangential throttling element can be moved into the at least one channel by means of an inertial force or tangential force, so that the greater the rotational speed of the at least one tangential throttling element, the smaller the flow cross-sectional area of the at least one channel becomes and vice versa.

In a further configuration, the at least one means comprises at least one elastic element, e.g. a spring, in order to move the at least one tangential throttling element out of the at least one channel in the event of a diminishing inertial force or tangentially, so that the flow cross-sectional area of the at least one channel is enlarged.

In particular, the at least one tangential throttling element and/or the at least one elastic element is arranged in the rotating part, for example the balancing disk.

A drive unit according to the invention, preferentially hybrid drive unit, particularly for a motor vehicle, preferentially comprises a combustion engine, particularly for driving the motor vehicle, preferentially at least one housing, at least one electric machine with a stator and a rotor preferentially arranged in the at least one housing, wherein the at least one electric machine is designed in accordance with an electric machine described in this patent application.

In a further configuration, the at least one housing is of multiple parts.

In an additional configuration, the housing is of one part.

In a further configuration, the at least one electric machine acts as motor and/or as generator.

A motor vehicle according to the invention comprises at least one electric machine described in this application and/or at least one drive unit described in this application.

In a further configuration, the motor vehicle comprises rechargeable batteries. The batteries supply the electric machine with electric current and upon deceleration of the motor vehicle the batteries can be charged by means of the electric machine by the electric current generated by the electric machine. In addition, the batteries can also be charged during a stoppage of the vehicle, for example from a public power network. In particular, the batteries are designed as lithium ion batteries.

### BRIEF DESCRIPTION OF THE DRAWINGS

Two exemplary embodiments of the invention are described in more detail in the following making reference to the enclosed drawings. It shows:

FIG. 1 a highly schematic representation of a hybrid drive unit,

FIG. 2 a longitudinal section of an electric machine in a first embodiment,

FIG. 3 a perspective view of a balancing disk of the electric machine according to FIG. 2,

FIG. 4 a longitudinal section of the electric machine in a second embodiment,

FIG. 5 an exploded representation of the electric machine in a third embodiment,

FIG. 6 a longitudinal section of the electric machine according to FIG. 5 and

FIG. 7 a view of a motor vehicle.

### DETAILED DESCRIPTION

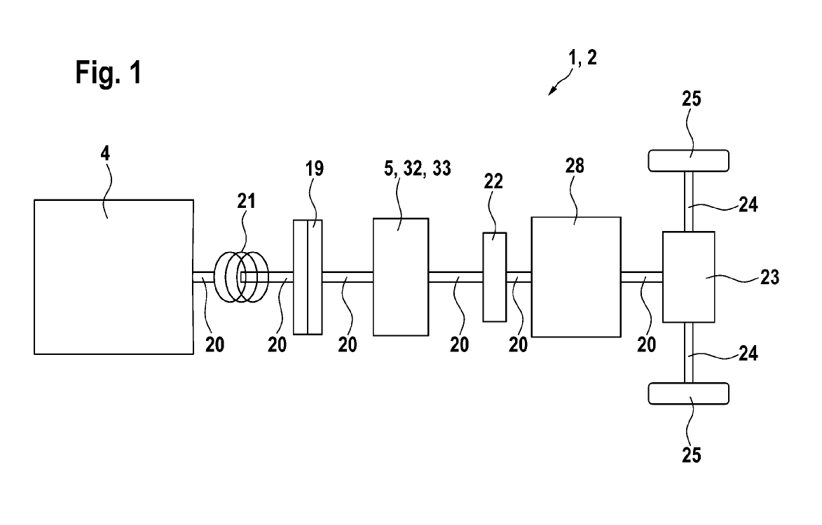

FIG. 1 shows a drive unit 1 for a motor vehicle 3 designed as a hybrid drive unit 2. The hybrid drive unit 2 for a motor vehicle 3 comprises a combustion engine 4 and an electric machine 5, which acts as motor 32 and generator 33, in each case for driving or decelerating the motor vehicle 3. The combustion engine 4 and the electric machine 5 are interconnected by means of a driveshaft 20. The mechanical coupling between the combustion engine 4 and the electric machine 5 can be established and cancelled by means of a clutch 19. Furthermore, an elasticity 21 is arranged in the driveshaft 20, which couples the combustion engine 4 and the electric machine 5 together. The electric machine 5 is mechanically coupled to a differential gear 23. In the driveshaft 20, which interconnects the electric machine 5 and the differential gear 23, a converter 22 and a transmission 28 are arranged. By means of the differential gear 23, the drive wheels 25 are driven via the wheel axles 24.

Instead of the arrangement of the combustion engine 4 and the electric machine for the motor vehicle 3 shown in the arrangement in FIG. 1, other possibilities are also conceivable (not shown). For example, the electric machine 5 can be arranged laterally on the combustion engine 4 and mechanically connected to the combustion engine 4 by means of a belt or a chain or of gear wheels instead of the driveshaft 20 (not shown) depicted in FIG. 1. In addition, the electric machine 5 could be arranged on a transmission, e.g. a differential gear, or the electric machine 5 can act as wheel hub motor and/or as wheel hub generator, i.e. be arranged in the region of a wheel hub (not shown).

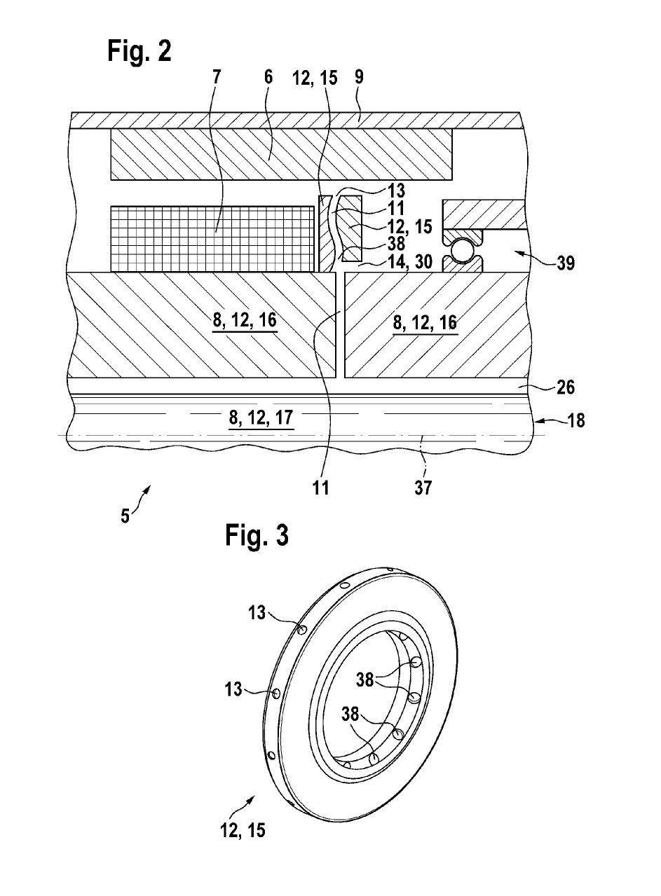

FIG. 2 shows the electric machine 5 for the hybrid drive unit 2 as internal pole machine in a first embodiment with a fixed stator 6 and a rotating rotor 7 of the hybrid drive unit 1 in a highly simplified representation, so that for example electrical lines, the windings of the stator 6 and of the rotor 7, and fixing means for the stator 6 are not shown or only shown highly simplified form. A shaft 8 consists of metal, e.g. steel, on which the rotor 7 is concentrically arranged, wherein the shaft 8 and the rotor 7 are mounted on a fixed housing 9 by means of a bearing 39. The stator 6 is arranged on the housing 9, concentrically around the rotor 7, and is attached thereto by means of fixing means (not shown). The stator 6 can also be fastened to the housing 9 without additional fixing means, e.g. by means of a press connection and/or shrink connection. The shaft 8, in this case, is connected to the driveshaft 20 of the hybrid drive unit 2 within the hybrid drive unit 2 or constitutes a part of the driveshaft 20.

FIG. 2 shows the electric machine 5 only above an axis 37 of the shaft 8. The shaft 8 of the electric machine 5 consists of an inner shaft 17 and a rotor shaft 16. The rotor shaft 16 is provided with an axial bore 18, in which the inner shaft 17 is arranged. Between the inner shaft 17 and the rotor shaft 16 a gap 26 that is circular in cross section is created because of the geometry of the axial bore 18 and of the diameter of the inner shaft 17. The rotor shaft 16 and the inner shaft 17 are rotating parts 12 of the electric machine 5, which rotate about the axis 37 of the shaft 8 or of the rotor shaft 16 and the inner shaft 17. The rotor shaft 16 is provided with radial channels 11 (in FIG. 2, only one channel 11 is shown). On the rotor shaft 16, a balancing disk 15 is additionally arranged. The balancing disk 15 has the objective of preventing unbalances on the rotor 7 and additionally delivering and distributing oil for the cooling. The balancing disk 15 (FIGS. 2 and 3) likewise comprises radially aligned channels 11, which at the radially viewed inner end has inlet openings 38 and outlet openings 13 at the radially viewed outer end.

From a cooling circuit 10 with a pump 27 and a pump sump 29 which is not shown in FIGS. 2 and 3 a liquid, particularly oil, is conducted into the gap 26 for cooling the stator 6 and the rotor 7. The oil in this case flows out of the gap 26 through the channels 11 worked into the rotor shaft 16 and subsequently through the channels 11 worked into the balancing disk 15. The oil thus flows out of the channels 11 of the rotor shaft 16 through the inlet openings 38 into the channels 11 of the balancing disk 15 and exits again at the outlet openings 13 of the balancing disk 15 and is sprayed onto the stator 6 and onto the rotor 7 for cooling the stator 6 and the rotor 7. Following this, the sprayed-out oil again collects in the collection region which is not shown and is additionally conducted in the pump sump 29 not shown in FIG. 2. The rotor shaft 16 and the balancing disk 15 as rotating parts 12 with the channels 11 also co-rotating have a suction effect because of the centrifugal forces that are active in the channels 11 so that these centrifugal forces can generate a vacuum in the cooling circuit 10.

The balancing disk 15 comprises a ring-shaped air intake opening 30, so that at the transition of the oil flowing through the channels 11 from the rotor shaft 16 to the balancing disk 15 a reduction of the vacuum in the channels 11 occurs, because the air intake opening 30 is connected to the atmospheric pressure and because of this air can flow into the channels 11 in the region between the balancing disk 15 and the rotor shaft 16. Because of this, the suction effect of the channels 11 in the balancing disk 15 can be substantially reduced, so that even at very high rotational speeds of the rotating parts 12 of the electric machine 5 only a small vacuum is generated by the channels 11. Because of this, an intensive vacuum can be avoided within the cooling circuit 10 that is not shown. Furthermore, at high rotational speeds of the rotating parts 12 quantities of oil which are not too large are sucked out of the cooling circuit 10 by the channels 11 so that upon an integration of the electric machine 5 into the drive unit 1 even additional components of the drive unit 1, which are to be cooled and/or lubricated by the oil, have sufficient oil for cooling at their disposal. Here, the oil continues to be conducted to the desired surfaces, i.e. the end face of the rotor 7 and the winding heads of the stator 6, which are to be cooled by the oil, because the outlet openings 13 are unchanged. Thus, the air intake opening 13 is a means 14 for reducing the rate of delivery per unit time of oil. Because of the integration of the air intake opening 13 into the balancing disk 15, advantageously no additional installation space for the means 14 for reducing the rate of delivery of oil is required.

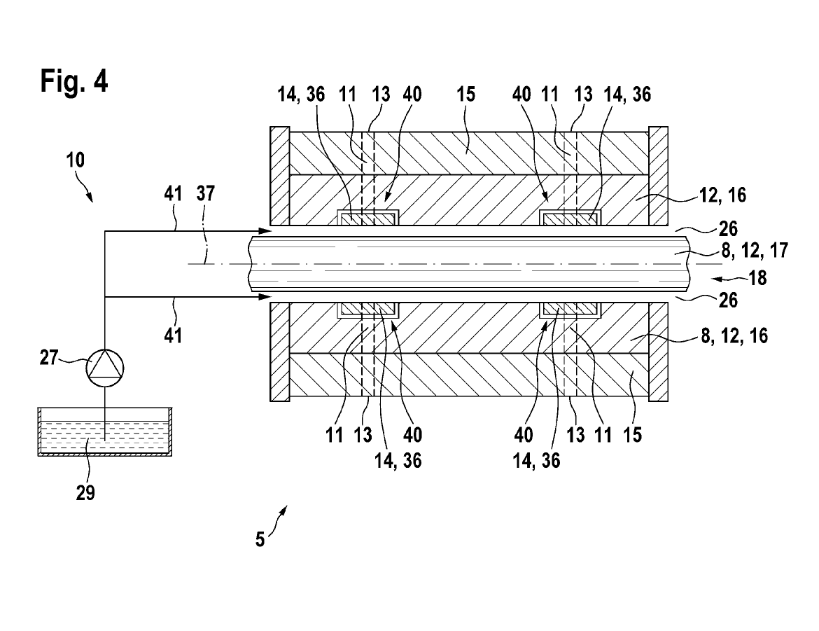

In FIG. 4, a second exemplary embodiment of the electric machine 5 is shown. The electric machine 5, similar to the first exemplary embodiment according to FIGS. 2 and 3, comprises a shaft 8 consisting of the inner shaft 17 and the rotor shaft 16, wherein between the inner shaft 17 and the rotor shaft 16 the gap 26 for passing through oil as cooling liquid is provided. The oil is conducted into the gap 26 by means of the pump 27 from the pump sump 29 through oil lines 41 in the gap 26. From a collecting region that is not shown the oil is again conducted back to the pump sump 29 by means of collecting lines which are not shown, so that the cooling circuit 10 is designed for the cooling by means of oil. FIG. 4 does not depict the stator 6, the rotor 7 and the housing 9 of the electric machine 5. Tangential recesses 40 are worked into the rotor shaft 16 on the inside in the region of the axial bore 18. In the tangential recesses 40 are located tangential throttling elements 36. The tangential throttling elements 36 are guided in the tangential recess 40 by means of guidance devices (not shown), e.g. a plain bearing by means of a tongue and groove connection (not shown) of the tangential throttling elements 36, and can thus be moved in tangential direction in the tangential recesses 40. Radial channels 11, which are represented by interrupted lines in FIG. 4, are worked into the rotor shaft 16 and in the balancing disk 15 arranged above said rotor shaft. Thus, the oil flows through the gap 26 and through the channels 11 and exits the outlet openings 13 on the balancing disk 15 for the cooling of the stator 6 and of the rotor 7 which are not shown in the Figure. Upon an increase of the rotational speed of the rotating parts 12 with the worked-in channels 11, i.e. of the rotor shaft 16 and the balancing disk 15, an inertial force or mass inertial force or a tangential force occurs, which acts on the tangential throttling element 36. Because of this, the tangential throttling elements 36 move in tangential direction in the tangential recesses 40. The tangential throttling elements 36 in this case are arranged relative to the channels 11 so that upon an increase of the rotational speed the flow cross-sectional area of the channels 11 is reduced. Because of the reduction of the flow cross-sectional area of the channels 11 the quantity of oil conveyed from the channels 11 per unit time is reduced.

Upon a reduction of the rotational speed of the rotating parts 12 the tangential throttling elements 36 again move back in the opposite direction, so that because of this the flow cross-sectional area of the channels 11 is enlarged and because of this the reduction of the rate of delivery per unit time of oil is reduced because of the reduction of the flow cross-sectional area of the channels by means of the tangential throttling elements 36. The return movement of the tangential throttling elements 36 upon a falling rotational speed is preferentially supported by an elastic element 34, e.g. a spring 35, which is not shown in FIG. 4, in order to ensure a return movement.

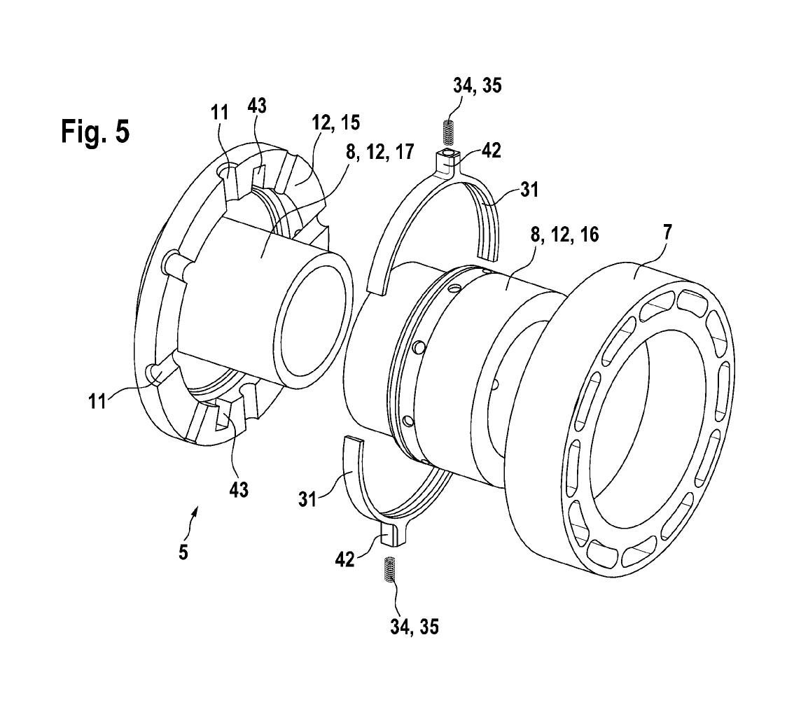

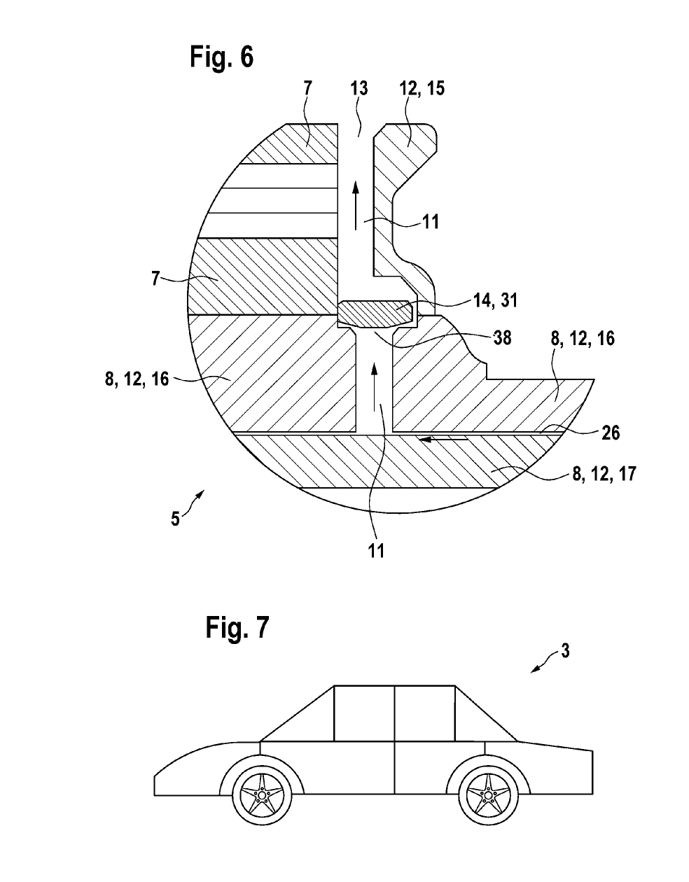

The third exemplary embodiment of the electric machine 5 is shown in FIGS. 5 and 6. The stator 6, the housing 9 and the cooling circuit 10 of the electric machine 5 are not shown in FIGS. 5 and 6. Radial recesses as channels 11 are worked into the balancing disk 15 (FIG. 5). Because of this, the channels 11 (FIG. 6) develop or form between the rotor 7 and the balancing disk 15. The electric machine 5 has two crescent-shaped radial throttling elements 31. On a socket 42 of the crescent-shaped radial throttling elements 31 the elastic element 34 designed as spring 35 is arranged in each case (FIG. 5). The elastic element 34 or the spring 35 are not shown in FIG. 6. The socket 42 with the spring 35 are arranged in a recess 43 of the balancing disk 15 (not shown). FIG. 6 shows the position of the radial throttling element 31 at a very low rotational speed. The oil conveyed by the pump 27 which is not shown in FIG. 6 of the cooling circuit 10 flows through the gap 26, the channels 11 in the rotor shaft 16 and the channels 11 in the balancing disk 15 to the outlet openings 13 and sprays onto the stator 6 (not shown) to be cooled and the rotor 7 (not shown in FIGS. 5 and 6) to be cooled. The oil thus flows about the radial throttling element 31 as shown in FIG. 6. Upon an increase of the rotational speed of the rotating parts 12 of the electric machine 5 the radial throttling element 31 radially moves outwardly (not shown) because of the higher centrifugal force, which acts on the radial throttling element 31. Because of this, the flow cross-sectional area of the channel 11 in the balancing disk 15 is reduced in the region of the radial throttling element 31, so that because of this the rate of delivery of oil per unit time is reduced. The centrifugal force acting on the radial throttling element 31 is counteracted by the spring force of the spring 35. The higher the rotational speed of the rotating parts 12, the further from an axis 37 of the shaft 8 not depicted in FIG. 6 is the radial throttling element 31 and the smaller is the flow cross-sectional area of the channels 11 in the region of the radial throttling elements 31. Upon a reduction of the rotational speed of the rotating parts 12 the centrifugal force acting on the radial throttling element 31 is reduced so that because of this the radial throttling element 31 radially moves in the direction of the axis 37 because of the spring force of the spring 35, so that because of this the flow cross-sectional area of the channel 11 is again enlarged in the region of the balancing disk 15. The greater the rotational speed of the rotating parts 12, the smaller the flow cross-sectional area of the at least one channel 11 in the region of the balancing disk 15 and vice versa. Because of this, it is advantageously avoided at a high rotational speed of the rotating parts 12 that because of the suction effect of the channels 11 a vacuum is generated in the cooling circuit 10 and because of this leaks can develop. The radial throttling element 31 as means 14 for reducing the rate of delivery of oil per unit time can also be designed such that from a determined rotational speed of the rotating parts 12 no oil flows through the channels 11 any longer, i.e. that the flow cross-sectional area of the channels 11 is zero or substantially equal to zero.

The details of the different exemplary embodiments can be combined with one another provided nothing to the contrary is mentioned.

Considered on the whole, substantial advantages are connected with the drive unit 1 according to the invention. The quantity of oil for cooling conveyed by the channels 11 because of the rotational movement of the channels 11 is reduced or limited by means 14, so that for other components 4, 23, 28 to be cooled and/or to be lubricated of the drive unit 1, e.g. the transmission 28 and/or the differential gear 23 and/or the combustion engine 4 sufficient oil for cooling and/or for lubricating remains which is conveyed by the pump 27 to these components 4, 23, 28.

1. An electric machine (5), comprising
a housing (9),
at least one shaft (8),
a stator (6) and a rotor (7),
a cooling circuit (10) for cooling the electric machine (5) with a liquid, wherein the liquid can be conveyed from at least one channel (11) aligned radially at least partially in at least one rotating part (12) of the electric machine (5) because of a rotational movement of the at least one channel (11),
at least one outlet opening (13) for draining the liquid from the at least one channel (11),
characterized in that the electric machine (5) comprises at least one means (14) for reducing the rate of delivery per unit time of liquid which can be conveyed by the at least one channel (11) because of the rotational movement of the at least one channel (11).

2. The electric machine as claimed in claim 1, characterized in that the at least one rotating part (12) is one of the at least one shaft (8) and a balancing disk (15).

3. The electric machine as claimed in claim 2, characterized in that the at least one shaft (8) comprises a rotor shaft (16) with an axial bore (18) and an inner shaft (17), wherein the inner shaft (17) is arranged in the axial bore (18) of the rotor shaft (16).

4. The electric machine as claimed in claim 3, characterized in that a gap (26) that is circular in cross section is present between the inner shaft (17) and the rotor shaft (16) for conducting the liquid.

5. The electric machine as claimed in claim 1, characterized in that the cooling circuit (10) includes a pump (27) for the additional delivery of the liquid.

6. The electric machine as claimed in claim 1, characterized in that the at least one means (14) comprises at least one air intake opening (30), wherein the at least one air intake opening (30) is connected in a fluidically conductive manner to the at least one channel (11) for reducing the rate of delivery per unit time of liquid.

7. The electric machine as claimed in claim 6, characterized in that the at least one air intake opening (30) is designed radially within the at least one outlet opening (13).

8. The electric machine as claimed in claim 1, characterized in that the at least one means (14) is designed such that the reduction of the rate of delivery per unit time of liquid takes place because of the rotational movement of the at least one channel (11) as a function of the rotational speed of the rotating part (12).

9. The electric machine as claimed in claim 1, characterized in that the at least one means (14) comprises at least one radial throttling element (31) that can be at least partially moved in radial direction, wherein the at least one radial throttling element (31) can be moved into the at least one channel (11) by means of a centrifugal force, so that the greater the centrifugal force, the smaller the flow cross-sectional area of the at least one channel (11) becomes.

10. The electric machine as claimed in claim 9, characterized in that the at least one means (14) comprises at least one elastic element (34) in order to move the at least one radial throttling element (31) in the event of a diminishing centrifugal force so that in the event of a diminishing centrifugal force the flow cross-sectional area of the at least one channel (11) is enlarged.

11. The electric machine as claimed in claim 9, characterized in that one of the at least one radial throttling element (31) and the at least one elastic element (34) is arranged in the rotating part (12).

12. The electric machine as claimed in claim 1, characterized in that the at least one means (14) comprises at least one tangential throttling element (36) at least partially moveable in tangential direction, wherein the tangential throttling element (36) can be moved into that the at least one channel (11) by means of an inertial force or tangential force so that the greater the rotational speed of the at least one tangential throttling element (36), the smaller the flow cross-sectional area of the at least one channel (11) becomes and vice versa.

13. The electric machine as claimed in claim 12, characterized in that the at least one means (14) comprises at least one elastic element (34) in order to move the at least one tangential throttling element (36) out of the at least one channel (11) in the event of a diminishing inertial force or tangentially, so that the flow cross-sectional area of the at least one channel (11) is enlarged.

14. The electric machine as claimed in claim 12, characterized in that one of at least one tangential throttling element (36) and the at least one elastic element (34) is arranged in the rotating part (12).

15. A drive unit (1) comprising
a combustion engine (4), and
at least one electric machine (5) with a stator (6) and a rotor (7),
characterized in that the at least one electric machine is designed as claimed in claim 1.

16. The electric machine as claimed in claim 1, characterized in that the liquid is oil.

17. The electric machine as claimed in claim 1, characterized in that the cooling circuit (10) is provided with a pump (27) for the additional delivery of the liquid from a pump sump (29).

18. The electric machine as claimed in claim 6, characterized in that the at least one air intake opening (30) is designed in the at least one rotating part (12).

19. The electric machine as claimed in claim 1, characterized in that the at least one means (14) is designed such that the reduction of the rate of delivery per unit time of liquid takes place because of the rotational movement of the at least one channel (11) as a function of the rotational speed of the at least one shaft (8), and in that a flow cross-sectional area of the at least one channel (11) is variable.

20. The drive unit as claimed in claim 15, characterized in that the drive unit is a hybrid drive unit for a motor vehicle, the combustion engine drives the motor vehicle and the electric machine drives the motor vehicle.
